(19) United States
(12) Patent Application Publication
(10) Pub. No.: US 2002/0037118 A1
(43) Pub. Date: Mar. 28, 2002

(54) Composite type sintered porous bearing

(76) Inventor: Motohiro Miyasaka, Nagareyama-shi (JP)

Correspondence Address: Roger T. Frost, KILPATRICK STOCKTON LLP, 2400 Monarch Tower, 3424 Peachtree Road, N.E., Atlanta, GA, 30326, US

(21) Appl. No.: 09/790,202

(22) Filed: Feb. 21, 2001

(30) Foreign Application Priority Data
Feb. 22, 2000 (JP) P2000-43865

(51) Int. Cl. F16C 33/02

(52) U.S. Cl. 384/279

(57) ABSTRACT

The invention relates to a composite type bearing in which bearing portions (11a, 12a) slidably supporting a rotary axis (S) are provided in both ends in an axial direction, and a middle escape portion (15) not being in contact with the rotary axis and a cylindrical magnet (13) are provided between the bearing portions (11a, 12a). The composite type sintered porous bearing is characterized in that at least two cylindrical sintered porous members (11, 12, 14) are fitted and joined so as to be united, and the magnet (13) is assembled within an outer peripheral space (16) in which an outer diameter between both end sides in an axial direction is formed to be smaller than an outer diameter of the both end sides.

### BACKGROUND OF THE INVENTION

1. Field of the Invention

The present invention relates to a bearing element for a spindle motor, a fan motor or the like in a precision device, and more particularly to a composite type sintered porous bearing having a magnet for a magnetic fluid lubricating oil.

2. Description of the Related Art

For a bearing element for a spindle motor or the like, there has been proposed a structure exemplified in FIG. 1 (which is not a prior art). The bearing structure is constituted by a sintered porous member in which bearing members 21 and 22 form a hole bearing surface, is attached to an inner hole of a housing 26 with keeping a predetermined interval and has an annular permanent magnet (hereinafter, refer to as a magnet) not being in contact with a rotary axis S, the magnet being attached to a middle portion of the bearing structure. Further, an end (a lower portion in FIG. 1) of the housing 26 is closed by a thrust-receiving member 27, and an annular seal member 28 which is not in contact with the rotary axis S is attached to another end (an upper portion in FIG. 1).

In this assembly, each of the members such as the magnet 23, the bearing members 21 and 22 and the like is successively pressed and a necessary amount of magnetic fluid lubricating oil is charged into the inner hole of the housing 26 before the rotary axis S is inserted. In view of an operation, since the rotary axis S is stably supported by the bearing members 21 and 22 corresponding to bearing portions for both shafts, a good sliding operation can be achieved by a magnetic fluid lubricating oil impregnated in a porous portion in the bearing members 21 and 22 and a magnetic fluid lubricating oil charged into a middle escape portion 25 between the magnet 23 and the rotary axis S, and the magnet 23 prevents the lubricating oil from leaking so as to keep the lubricating oil for a long time, it is possible to correspond to a small size and a high speed rotation.

In the composite type bearing having the magnet mentioned above, the respectively manufactured members are supplied to an assembling plant so as to be successively attached at a high accuracy, however, in an assembling process, it is desired to reduce the number of members employ a structure which can easily achieve an assembling accuracy, for the reason of improving a productivity or the like. Further, since a magnet is easily cracked and broken, it is required to carefully pressurize the magnet at a time of assembling, and a high level assembling technique is required so as to improve an accuracy of inner diameter of the bearing at a time of assembling. These requirements are inevitable in small sizing; for example, a diameter of the hole-bearing surface is 1 mm.

### SUMMARY OF THE INVENTION

An object of the present invention is to achieve an excellent assembling characteristic, prevent a reduction of bearing accuracy which is easily generated at a time of assembling, and further improve an operating quality.

The first aspect of the invention provides a composite type sintered porous bearing comprising: bearing portions slidably supporting a rotary axis and provided at both ends in an axial direction; a middle escape portion provided between the both bearing portions in such a manner as not to be in contact with the rotary axis; and a cylindrical magnet, wherein at least two cylindrical sintered porous members are fitted and joined to each other so as to be united, and the magnet is simultaneously assembled in corresponding inner holes of the sintered porous members at a time of fitting and joining so as to form the middle escape portion.

The second aspect of the invention provides a composite type sintered porous bearing comprising: bearing portions slidably supporting a rotary axis and provided at both ends in an axial direction; a middle escape portion provided between the both bearing portions in such a manner as not to be in contact with the rotary axis; and a cylindrical magnet, wherein at least two cylindrical sintered porous members are fitted and joined to each other so as to be united, and the magnet is assembled within an outer peripheral space in which an outer diameter between both ends in an axial direction is formed so as to be smaller than an outer diameter of both ends.

According to the first and second aspect of the invention, with respect to the composite type bearing slidably supporting the rotary axis by the bearing portions at both ends and having the magnet, the structure is made such that two or more sintered porous members are provided, when the sintered porous members are integrated in accordance with the fitting and joining operation, the magnet is inserted into the inner holes of the corresponding sintered porous members in the former case, and the magnet is inserted into the outer peripheral spaces of the sintered porous members in the latter case. Accordingly, in this assembly, since the sintered porous members are fitted and joined to each other, it is possible to simultaneously assemble the magnet in the corresponding portions, and an excellent assembling characteristic can be achieved in comparison with the structure such as the proposed bearing structure in which the magnet is pressurized and inserted into the housing inner hole.

According to the first and second aspects of the invention, the magnet is assembled in the bearing with play. In this case, the magnet is structured, in the same manner as that of the proposed bearing structure, such as to attract and hold the magnetic fluid lubricating oil impregnated in the sintered porous member and the magnetic fluid lubricating oil charged in the middle escape portion by a magnetic force so as to prevent the oil from leaking and scattering to the external portion. Therefore, a good sliding characteristic of the bearing portion or the rotary axis is maintained. Then, in the assembling operation, the proposed bearing structure positions and fixes the magnet by press-inserting the magnet into the housing inner hole, however, there is a risk that a crack or a breakage is generated as mentioned above. In accordance with the structure of the present invention, it is possible to securely avoid the risk that the magnet is broken in the proposed bearing structure, by assembling the magnet with play at a time of fitting and joining the sintered porous members to each other.

As using aspects of each of the invented products, one aspect shows that the sintered porous member is constructed as a structure provided with a mounting portion or the like so as to be directly assembled in the apparatus side, and the other aspect shows that the sintered porous member is assembled in the apparatus side via a housing or an exclusive mounting member, any one of these aspects may be employed. The magnet in each of the present inventions is formed in a cylindrical shape, and this cylindrical shape includes a simple cylinder, a cylindrical shape with a slit in an axial direction formed in a C shape in a horizontal cross section, a cylindrical shape obtained by collecting separated pieces in an axial direction, a cylindrical shape obtained by layering cylinders in an axial direction of the cylinder and the like.

### BRIEF DESCRIPTION OF THE DRAWINGS

FIG. 1 is a vertical cross sectional view showing a proposed bearing structure;

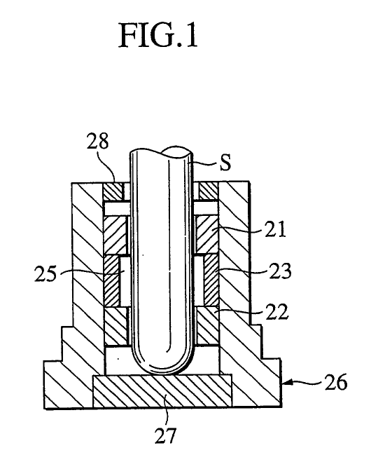

FIGS. 2A to 2D are vertical cross sectional views showing four bearing structures in accordance with an embodiment of the present invention;

FIGS. 3A to 3D are vertical cross sectional views showing four bearing structures in accordance with another embodiment of the present invention; and

FIG. 4 is a vertical cross sectional view showing a bearing structure in accordance with the other embodiment of the present invention.

### DETAILED DESCRIPTION OF THE PREFERRED EMBODIMENTS

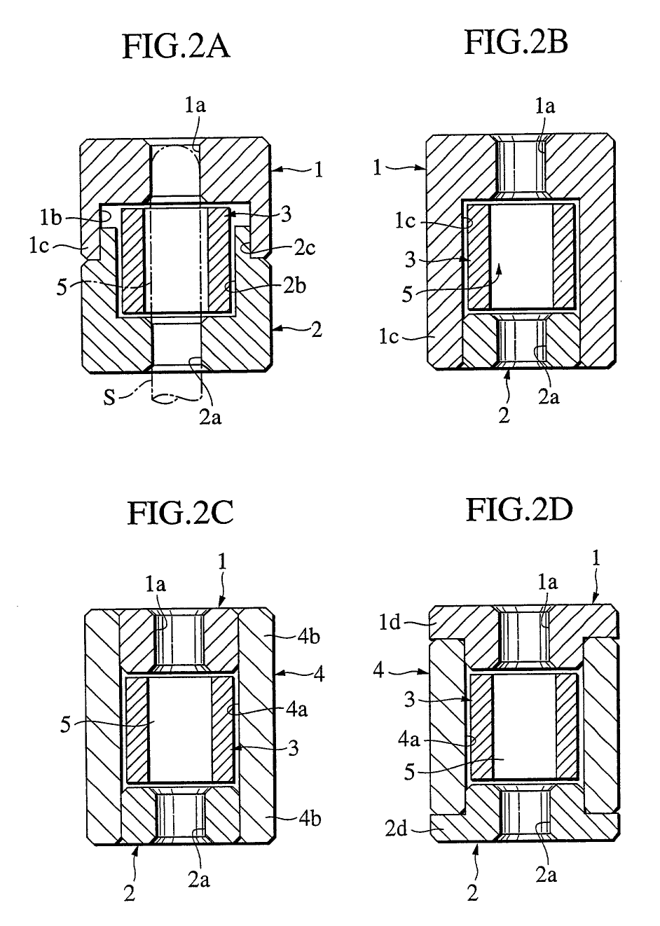

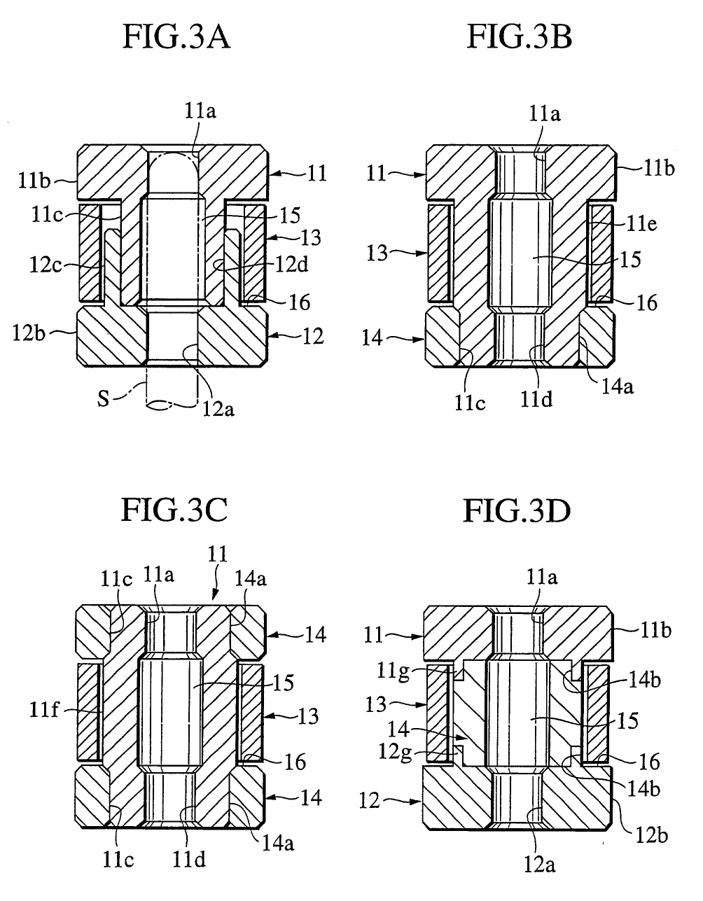

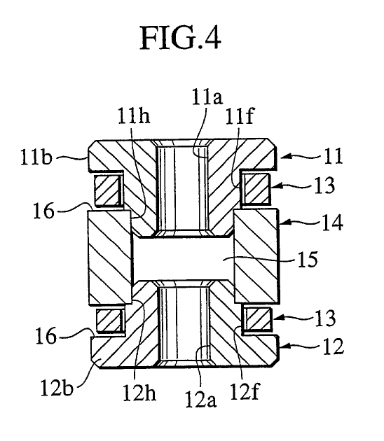

A description of embodiments will be in detail given in accordance with the present invention. FIGS. 2A to 2D show four embodiments in which a middle escape portion is formed by a magnet, and FIGS. 3A to 3D and FIG. 4 show five embodiments in which a magnet is assembled in an outer peripheral small diameter portion.

(First Embodiment)

A composite type sintered porous bearing shown in FIG. 2A comprises two bearing members 1 and 2 and a magnet 3. The bearing members 1 and 2 are cylindrical sintered porous members, in which bearing portions 1a and 2a forming a hole bearing surface are positioned at both ends in an axial direction holding the state being fitted and joined to each other so as to be integrally united, and the magnet 3 is arranged in a large diameter inner hole 2b provided between both bearing portions 1a and 2a. In this case, the bearing member 1 is structured such that a cylindrical inner hole in one end side forms the small diameter bearing portion 1a, an inner hole in another end side is formed so as to have a large diameter portion, and a column portion 1c forming the large diameter inner hole 1b becomes a fitting and joining portion. The bearing member 2 is structured such that a cylindrical inner hole in one end side forms the small diameter bearing portion 2a, an inner hole in another end side is formed so as to have a large diameter portion, and the magnet 3 is fitted to the large diameter inner hole 2b with play. A column portion corresponding to the large diameter inner hole 2b is formed in a small diameter step portion 2c corresponding to a fitting and joining portion in a part of an outer periphery of the column portion. It is sufficient that the column portion 1c and the small diameter step portion 2c have a relation that one is joined to another in an inserting manner. The magnet 3 is a cylindrical permanent magnet, and forms a middle escape portion 5 having an inner diameter portion, which is not in contact with a rotary axis S slidably supported to both bearing portions 1a and 2a. The magnet 3 is not limited in view of a material and a producing method, however, it is desirable to employ a so-called bond magnet (a plastic magnet) produced by fixing rare-earth magnetic powders being excellent in both of a modeling characteristic and a magnetic force by a binder such as a resin or the like. Since the magnet 3 is generally hard and fragile, a magnet end surface and an outer periphery of the magnet are adjusted to a size which is not pressed strongly by the bearing members 1 and 2, and the magnet 3 is assembled in the large diameter inner hole 2b and the large diameter inner hole 1b in accordance with a clearance fit or with play. A magnetization and a magnetic force operation of the magnet 3 are the same as those of the proposed bearing structure.

Accordingly, with respect to the produced bearing members 1 and 2 and the magnet 3 in this assembly, holding the state inserting the magnet 3 into the large diameter inner hole 2b, the bearing members 1 and 2 are arranged in an axial direction and joined through the column portion 1c and the small diameter step portion 2c in accordance with a press-insertion or the like. In this case, the bearing members 1 and 2 are made of the general sintered material, and a suitable method is selected among a method of sizing after joining in a sintered state, a method of simultaneously sizing and joining and a method of press inserting after sizing the bearing members 1 and 2. Further, both of the bearing members 1 and 2 are made of the general porous sintered material and applied to the sizing operation. However, both of the bearing members 1 and 2 are the same as the proposed bearing structure in view that detailed structures can be applied, for example. The materials of both members are different, the number of porosities of both members is different, inner diameters of both members are different, a groove exists on the hole bearing surfaces of the bearing portions 1a and 2a, the hole bearing surface is formed into a triangular shape and the like. In the using aspect, the rotary axis S is inserted holding the state charging a necessary amount of magnetic fluid lubricating oil in the middle escape portion 5, and slidably supported by the hole bearing surfaces in both bearing portions 1a and 2a.

In the structure mentioned above, each of the bearing members 1 and 2 is formed by the sintered porous member, they are united in accordance with the fitting and joining operation, and at the same time, the magnet 3 is assembled in accordance with an inserting way. As mentioned above, the members are mutually positioned in accordance with the fitting and joining operation between the bearing members 1 and 2 at a time of assembling, and are assembled at a high accuracy by setting the shapes and the fitting sizes of the column portion 1c and the small diameter step portion 2c. This means that an assembling can be easily performed, an assembling accuracy is stable and a yield can be improved in comparison with the proposed bearing structure that each of the members is independently positioned as in the proposed bearing structure and the inner diameter of the bearing portion and the accuracy of the middle escape portion are varied in correspondence to the press-insertion degree of the magnet or the like.

(Second Embodiment)

FIG. 2B shows a modified embodiment of the fitting and joining between the bearing members in accordance with the first embodiment. The number of the members is three comprising two bearing members corresponding to the sintered porous members and the cylindrical magnet. The same reference numerals are attached to the corresponding members in the first embodiment and a description will be mainly given in detail of modified points. That is, in this composite type sintered porous bearing, the bearing portions 1a and 2a forming the hole bearing surface are positioned at both ends in an axial direction holding the state that the bearing members 1 and 2 are fitted and joined to each other so as to be integrally united, and the magnet 3 is arranged between both bearing portions 1a and 2a. In this case, the bearing member 1 is structured such that the cylindrical inner hole in one end side forms the small diameter bearing portion 1a, the inner hole in another end side is formed so as to have a large diameter portion, and the column portion 1c in an end side forming the large diameter inner hole 1b becomes a fitting and joining portion. The bearing member 2 is as a whole formed into a simple cylindrical shape fitted and joined to the end side column portion 1c of the large diameter inner hole 1b, and the inner hole of the bearing member 2 forms the small diameter bearing portion 2a. The magnet 3 is a permanent magnet, and has an inner diameter which is not in contact with a rotary axis (not shown) slidably supported to both bearing portions 1a and 2a, thereby forming the middle escape portion 5 mentioned above. Accordingly, with respect to the bearing members 1 and 2 and the magnet 3 in this assembly, holding the state inserting the magnet 3 into the large diameter inner hole 1b, the bearing members 1 and 2 are arranged in an axial direction, and joined and united in accordance with press inserting the bearing member 2 into the large diameter inner hole 1b. In summary, the matters mentioned in the first embodiment are applied as they are, except the shapes of the bearing members 1 and 2.

(Third Embodiment)

An embodiment shown in FIG. 2C corresponds to an embodiment in which a composite type sintered porous bearing comprises four members including two bearing members and a fixing member corresponding to sintered porous members, and a cylindrical magnet, with respect to two embodiments mentioned above. The members 1, 2 and 3 except the fixing member 4 are structured such as to have the same operations, and a description will be mainly given in detail of modified points by attaching the same reference numerals to the corresponding members in the first embodiment. That is, in this composite type sintered porous bearing, the bearing members 1 and 2 are respectively fitted and joined to both inner ends of the fixing member 4 so as to be united, the bearing portions 1a and 2a forming the hole bearing surface are positioned at both ends in an axial direction, and the magnet 3 is arranged between both bearing members 1 and 2. In this case, the fixing member 4 is a porous shaft member made of a sintered alloy, and is formed into a simple cylindrical shape having a continuous inner diameter interior hole 4a, and column portions 4b at both ends form fitting and joining portions. The bearing members 1 and 2 are simple cylindrical sintered porous members having the number of porosities made smaller than the number of porosities of the fixing member 4, form the bearing portions 1a and 2a corresponding to the hole bearing surface, and are fitted and joined to both end column portions 4b of the inner diameter interior hole 4a. The magnet 3 is a permanent magnet, and forms the middle escape portion 5 having an inner diameter which is not in contact with a rotary axis (not shown) slidably supported to both bearing portions 1a and 2a. Accordingly, also in this assembly, with respect to the bearing members 1 and 2 and the magnet 3, holding the state inserting the magnet 3 into the inner diameter interior hole 4a, the bearing members 1 and 2 are arranged in both side axial directions of the fixing member 4, and joined and united in accordance with press inserting the bearing members 1 and 2 into the inner diameter interior hole 4b. In summary, the matters mentioned in each of the embodiments mentioned above are applied, except the point that the fixing member 4 is interposed.

(Fourth Embodiment)

An embodiment shown in FIG. 2D is a modified embodiment of the fitting and joining between the fixing member 4 and each of the bearing members 1 and 2 in accordance with the third embodiment. The same reference numerals are attached to the corresponding members in the third embodiment. In this composite type porous bearing, the bearing portions 1a and 2a forming the hole bearing surface are positioned at both ends in an axial direction holding the state that the bearing members 1 and 2 are fitted and joined to each other so as to be integrally united, and the magnet 3 is arranged between both bearing portions 1a and 2a. A structure different from the third embodiment is that the bearing members 1 and 2 have flange portions 1d and 2d and a length of the fixing member 4 is made short in correspondence to a thickness of the flange portions 1d and 2d. In this assembly, the bearing members 1 and 2 are respectively fitted and joined to the corresponding inner diameter internal hole 4a of the fixing member 4, however, since the flange portions 1d and 2d are brought into contact with the corresponding end surfaces of the fixing member 4, so that the positions of the flange portions 1d and 2d are restricted at this time and an assembling operation can be better performed.

(Fifth Embodiment)

A composite type sintered porous bearing shown in FIG. 3A comprises two bearing members 11 and 12 and a magnet 13. The bearing members 11 and 12 are cylindrical sintered porous members, in which a bearing portions 11a and 12a forming hole bearing surfaces are positioned at both ends in an axial direction holding the state of being fitted and joined to each other so as to be integrally united, and the magnet 13 is assembled within an outer peripheral space 16 corresponding to an outer peripheral small diameter portion 12c of the bearing member 12 and an outer peripheral small diameter portion 11c of the bearing member 11. That is, the bearing member 11 is structured such that a cylindrical inner hole in one end side forms the small diameter bearing portion 11a, an inner hole in another end side forms a middle escape portion 15 having a large diameter portion. An outer peripheral shape is formed into a step shape, one end side corresponding to the bearing portion 11a is formed in an outer peripheral large diameter portion 11b, and the other portions are formed in an outer peripheral small diameter portion 11c. The outer peripheral small diameter portion 11c corresponds to the middle escape portion 15, and a part of a column portion forming the outer peripheral small diameter portion 11c corresponds to a fitting and joining portion. The bearing member 12 is structured such that a cylindrical inner hole in one end side forms the small diameter bearing portion 12a, an inner hole in another end side is formed so as to have a large diameter portion, and a large diameter inner hole 12d corresponds to a fitting and joining portion. An outer peripheral shape is formed into a step shape in which one end side corresponding to the bearing portion 12a is formed in an outer peripheral large diameter portion 12b and the other portions are formed in an outer peripheral small diameter portion 12c. It is sufficient that the column portion of the outer peripheral small diameter portion 11c and the large diameter inner hole 12d have a relation that one is joined to another in an inserting way. The magnet 13 is a cylindrical permanent magnet. A whole size and an inner diameter of the magnet 13 are received within the outer peripheral space 16 sectioned by both of the outer peripheral large diameter portions 11b and 12b and the outer peripheral small diameter portions 11c and 12c. The magnet 13 is arranged in the outer peripheral space 16 with play. Detail aspects of the magnet 13 are the same as those mentioned with respect to the magnet 3 in accordance with the first embodiment.

Accordingly, in this assembly, with respect to the produced bearing members 11 and 12 and the magnet 13, holding the state inserting the magnet 13 into the outer peripheral small diameter portion 12c, the bearing members 11 and 12 are arranged in an axial direction and joined through the column portion 11c of the outer peripheral small diameter portion and the large diameter inner portion 12d in accordance with a press-insertion or the like. In this case, the bearing members 11 and 12 are made of a general sintered material, and a suitable method is selected among a method of sizing after joining in a sintered state, a method of simultaneously sizing and joining and a method of press inserting after sizing of the bearing members 11 and 12. Further, both of the bearing members 11 and 12 are made of the general porous sintered material and applied to the sizing operation. However, detailed structures can be applied, for example, the materials of both members are different, the number of porosities is different, inner diameters of both members are different, a groove exists on the hole bearing surfaces of the bearing portions 11a and 12a, the hole bearing surface is formed into a triangular shape and the like. In the using aspect, the rotary axis S is inserted holding the state charging a necessary amount of magnetic fluid lubricating oil in the middle escape portion 15, and slidably supported by the hole bearing surfaces in both bearing portions 11a and 12a. These structures are the same as those of the first embodiment. Further, in the structure mentioned above, each of the bearing members 11 and 12 is formed by the sintered porous member, they are united in accordance with the fitting and joining operation, and at the same time, the magnet 13 is assembled in accordance with an inserting way. As mentioned above, the members are mutually positioned in accordance with the fitting and joining operation between the bearing members 11 and 12 at a time of assembling, and are assembled at a high accuracy by setting the shapes and the fitting sizes of the column portion of the outer peripheral small diameter portion 11c and the large diameter inner hole 12d.

(Sixth Embodiment)

An embodiment shown in FIG. 3B corresponds to a modified embodiment of the fifth embodiment. A description will be mainly given in detail of modified points by attaching the same reference numerals to the corresponding members to those of the fifth embodiment. The constituting members comprise three members including one bearing member 11 and a fixing member 14 corresponding to the sintered porous members and the cylindrical magnet 13. Then, in this composite type sintered porous bearing, the bearing portions 11a and 11d formed in the inner peripheries of both ends in the bearing member 11 are positioned at both ends in an axial direction holding the state that the bearing members 11 and 12 are fitted and joined to each other so as to be united, and the magnet 13 is arranged within the outer peripheral space 16 sectioned by an outer peripheral middle small diameter portion 11e formed in the bearing member 11 and the fixing member 14. That is, the bearing member 11 is structured such that the bearing portions 11a and 11d forming hole bearing surfaces are positioned at both cylindrical ends, and the middle escape portion 15 having a large diameter inner hole is formed between both of the bearing portions 11a and 11d. An outer peripheral shape is formed into two steps in which one end side corresponding to the bearing portion 11a is formed in an outer peripheral large diameter portion 11b, the outer peripheral middle small diameter portion 11e has a smaller diameter portion than that of the outer peripheral large diameter portion 11b, and another end side is formed in an outer peripheral small diameter portion 11c having a smaller diameter portion than that of the outer peripheral middle small diameter portion 11e. The column portion forming the outer peripheral small diameter portion 11c becomes a fitting and joining portion. The magnet 13 is fitted to the outer peripheral middle small diameter portion 11e with play. The fixing member 14 is a simple cylindrical porous bearing member made of a sintered alloy, and an inner diameter internal hole 14a corresponds to a fitting and joining portion corresponding to the outer peripheral small diameter portion 11c. The magnet 13 is a cylindrical permanent magnet inserted into the outer peripheral middle small diameter portion 11e. A whole size and an inner diameter of the magnet 13 are received within the outer peripheral space 16 sectioned by the outer peripheral middle small diameter portion 11e, the outer peripheral large diameter portion 11b and the fixing member 14, and is arranged in the outer peripheral middle small diameter portion 11e with play. Detail aspects of the magnet 13 are as mentioned above.

Accordingly, in this assembly, with respect to the bearing members 11, the fixing member 14 and the magnet 13, holding the state inserting the magnet 13 into the outer peripheral middle small diameter portion 11e, the bearing member 11 and the fixing member 14 are arranged in an axial direction, and joined and united by press inserting the fixing member 14 into the outer peripheral small diameter portion 11c. Detail aspects are as mentioned in each of the embodiments described above.

(Seventh Embodiment)

An embodiment shown in FIG. 3C corresponds to a modified embodiment of the sixth embodiment. A description will be mainly given in detail of modified points by attaching the same reference numerals to the corresponding members to those of the sixth embodiment. The constituting members comprise four members including one bearing member 11 and two fixing members 14 and 14 corresponding to the sintered porous members and the cylindrical magnet 13. Then, in this composite type sintered porous bearing, holding the state that two fixing members 14 are fitted and joined to both ends of the bearing member 11 so as to be united, the magnet 13 is arranged within the outer peripheral space 16 sectioned by the fixing members 14 disposed at both sides and a middle outer peripheral portion 11f of the bearing member 11. In this case, the bearing member 11 is structured such that the bearing portions 11a and 11d forming a hole bearing surface are positioned at both cylindrical ends, and the middle escape portion 15 having a large diameter inner hole is formed between both of the bearing portions 11a and 11d. An outer peripheral shape is formed such that both end sides corresponding to the respective bearing portions 11a and 11d are formed in the outer peripheral small diameter portions 11c and the middle outer peripheral portion 11f is provided between the outer peripheral small diameter portions 11c. The outer peripheral small diameter portions 11c in both sides correspond to fitting and joining portions, and the magnet 13 is fitted to the middle outer peripheral portion 11f with play. Two fixing members 14 are simple cylindrical porous bearing members made of a sintered alloy, and the inner diameter internal hole 14a corresponds to a fitting and joining portion corresponding to the outer peripheral small diameter portion 11c. The magnet 13 is a cylindrical permanent magnet inserted into the middle outer peripheral portion 11f. A whole size and an inner diameter of the magnet 13 are received within the outer peripheral space 16 sectioned by the middle outer peripheral portion 11f and both of the fixing members 14, and is arranged in the middle outer peripheral portion 11f with play. Detail aspects of the magnet 13 are as mentioned above.

Accordingly, in this assembly, with respect to the bearing member 11, two fixing members 14 and the magnet 13, holding the state inserting the magnet 13 into the middle outer peripheral portion 11f, the bearing member 11 and the respective fixing members 14 are arranged in an axial direction, and joined and united by press inserting the respective fixing members 14 into the corresponding outer peripheral small diameter portion 11c. Detail aspects are as mentioned in each of the embodiments described above.

(Eighth Embodiment)

An embodiment shown in FIG. 3D corresponds to an embodiment in which the composite type sintered porous bearing comprises four members including two bearing members and a fixing member corresponding to the sintered porous members, and the cylindrical magnet, with respect to the seventh embodiment. A description will be mainly given in detail of modified points by attaching the same reference numerals to the corresponding members to those of the seventh embodiment. In this composite type sintered porous bearing, the bearing members 11 and 12 are respectively fitted and joined to the corresponding ends of the fixing member 14 so as to be united, the bearing portions 11a and 12a forming the hole bearing surface are positioned at both ends in an axial direction, and the magnet 13 is arranged within the outer peripheral space 16 sectioned by the outer peripheral large diameter portions 11b and 12b of both of the bearing members 11 and 12, joining portions 11g and 12g and the outer periphery of the fixing member 14. That is, the bearing members 11 and 12 are formed in a cylindrical porous member, form the bearing portions 11a and 12a by the inner holes, and have the ring-shaped fitting and joining portions 11g and 12g in the end surface sides. The joining portions 11g and 12g are formed so as to have a small diameter with the outer peripheral large diameter portions 11b and 12b and the step portion in the outer diameter, and so as to have a larger diameter portion than the inner holes of the bearing portions 11a and 12a in the inner diameter. The fixing member 14 is a cylindrical porous bearing member made of a sintered alloy, and the inner diameter internal hole forms the middle escape portion 15 having a larger diameter portion than the bearing portions 11a and 12a. Further, both outer peripheral ends are formed in a stepped small diameter joining portion 14b, and when the small diameter joining portion 14b is fitted and joined to the corresponding joining portions 11g and 12g, the outer periphery of the fixing member 14 becomes aligned with the joining portions 11g and 12g at both ends. The magnet 13 is a cylindrical permanent magnet inserted into the aligned outer periphery. A whole size and an inner diameter of the magnet 13 are received within the outer peripheral space 16 sectioned by the outer peripheral large diameter portions 11b and 12b, the joining portions 11g and 12g and the outer periphery of the fixing member 14, and is arranged in the joining portions 11g and 12g with play. Detail aspects of the magnet 13 are as mentioned above.

Accordingly, in this assembly, with respect to two bearing members 11, the fixing member 14 and the magnet 13, holding the state inserting the magnet 13 into the outer periphery of the fixing member 14, both of the bearing members 11 and 12 and the fixing member 14 are arranged in an axial direction, and joined and united by press inserting the respective small diameter joining portions 14b into the corresponding joining portions 11g and 12g. Detail aspects are as mentioned in each of the embodiments described above.

(Ninth Embodiment)

An embodiment shown in FIG. 4 corresponds to an embodiment in which the composite type sintered porous bearing comprises five members including two bearing members and a fixing member corresponding to the sintered porous members, and two cylindrical magnets, with respect to the eighth embodiment. A description will be mainly given in detail of modified points by attaching the same reference numerals to the corresponding members and portions to those of the seventh embodiment. In this composite type sintered porous bearing, the bearing members 11 and 12 are respectively fitted and joined to the corresponding ends of the fixing member 14 so as to be united, the bearing portions 11a and 12a forming the hole bearing surfaces are positioned at both ends in an axial direction, and two magnets 13 are arranged within the outer peripheral space 16 sectioned by the outer peripheral large diameter portions 11b and 12b of both of the bearing members 11 and 12, and the corresponding end surfaces of the fixing member 14. The bearing members 11 and 12 in this case are formed in a cylindrical porous member, and form the bearing portions 11a and 12a by the inner holes. An outer peripheral shape is structured such that the other portions than the outer peripheral large diameter portions 11b and 12b are formed in the outer peripheral middle small diameter portions 11f and 12f, and end sides of the outer periphery are formed in engaging and joining portions 11h and 12h having smaller diameter portions than the outer peripheral middle small diameter portions 11f and 12f. The fixing member 14 is a cylindrical porous bearing member made of a sintered alloy. The diameter of the inner diameter internal holes of the fixing member 14 is larger than that of the bearing portions 11a and 12a. The fixing member 14 forms the joining portion corresponding to the engaging and joining portions 11h and 12h. Then, in this structure, when the respective bearing members 11 and 12 are fitted and joined to the corresponding ends of the fixing member 14, the middle escape portion 15 is formed between the end surfaces of the engaging and joining portions 11h and 12h and the inner hole of the fixing member 14. Further, the outer peripheral middle small diameter portions 11f and 12f respectively form the outer peripheral spaces 16 by the respective end surfaces of the fixing member 14 and the corresponding end surfaces of the outer peripheral large diameter portions 11b and 12b. Each of the magnets 13 is a cylindrical permanent magnet, is received within each of the outer peripheral spaces 16, and is arranged in the outer peripheral middle small diameter portions 11f and 12f with play. Detail aspects of the magnets 13 are as mentioned above.

Accordingly, in this assembly, with respect to two bearing members 11, the fixing member 14 and the magnets 13, holding the state inserting the respective magnets 13 into the outer peripheral middle small diameter portions 11f and 12f, both of the bearing members 11 and 12 and the fixing member 14 are arranged in an axial direction. Further, both of the bearing members 11 and 12 and the fixing member 14 are joined and united by press inserting the respective engaging and joining portions 11h and 12h into the inner diameter internal holes of the fixing member 14. At this time, with respect to the pressing amount of the fixing member 14, the position of the end surface of the fixing member 14 is restricted by being brought into contact with the corresponding end surfaces of the engaging and joining portions 11h and 12h. Detail aspects are as mentioned in each of the embodiments described above.

What is claimed is:

1. A composite type sintered porous bearing comprising:
bearing portions slidably supporting a rotary axis and provided at both ends in an axial direction;
a middle escape portion provided between said both bearing portions in such a manner as not to be in contact with said rotary axis; and
a cylindrical magnet, wherein at least two cylindrical sintered porous members are fitted and joined to each other so as to be united, and said magnet is simultaneously assembled in corresponding inner holes of said sintered porous members at a time of fitting and joining so as to form said middle escape portion.

2. A composite type sintered porous bearing according to claim 1, wherein said magnet is assembled in said bearing with play.

3. A composite type sintered porous bearing comprising:
bearing portions slidably supporting a rotary axis and provided at both ends in an axial direction;
a middle escape portion provided between said both bearing portions in such a manner as not to be in contact with said rotary axis; and
a cylindrical magnet,
wherein at least two cylindrical sintered porous members are fitted and joined to each other so as to be united, and said magnet is assembled within an outer peripheral space in which an outer diameter between both ends in an axial direction is formed so as to be smaller than an outer diameter of both ends.

4. A composite type sintered porous bearing according to claim 3, wherein said magnet is assembled in said bearing with play.
